(19) United States
(12) Patent Application Publication
(10) Pub. No.: US 2016/0077986 A1
(43) Pub. Date: Mar. 17, 2016

(54) ELECTRONIC APPARATUS PROVIDING REAL-TIME SWITCHING AND SHARING OF USB ELECTRONIC DEVICES AMONG HOSTS

(71) Applicant: ASIX ELECTRONICS CORPORATION, HSINCHU (TW)

(72) Inventors: JACK WANG, NEW TAIPEI (TW); YUNG-CHI CHUNG, HSINCHU CITY (TW); TSUNG MING SHEN, HSINCHU COUNTY (TW); TING-HAN SU, HSINCHU CITY (TW)

(21) Appl. No.: 14/838,032

(22) Filed: Aug. 27, 2015

(30) Foreign Application Priority Data
Sep. 12, 2014 (TW) 103131499

(51) Int. Cl. G06F 13/20; G06F 13/40; G06F 13/42; H01R 24/60

(52) U.S. Cl. CPC G06F 13/20; H01R 24/60; G06F 13/4068; G06F 13/4282; H01R 2107/00

(57) ABSTRACT

The present disclosure provides an electronic apparatus that comprises a number of Universal Serial Bus (USB) device control modules, a microprocessor, a priority arbitration module, a USB host control module and a USB hub module. The USB device control modules are configured to receive from and send to a host a USB electric signal. The microprocessor is configured to generate a number of virtual USB hub modules in a memory. Each of the virtual USB hub modules is configured to generate a USB device enumeration signal, in response to an electric connection status between a USB electronic device and the USB hub module, and to send the USB device enumeration signal via a corresponding one of the USB device control modules to the host. The priority arbitration module is configured to, in response to the availability of the USB electronic device, transmit the USB electric signal issued from the host to the USB electronic device via the USB host control module and the USB hub module.

### TECHNICAL FIELD

The present invention in general relates to a universal serial bus (USB) electronic apparatus and, in particular, to an electronic apparatus that provides real-time switching and sharing of USB electronic devices among hosts.

### BACKGROUND

USB has become one of the major standard interfaces for electronic products such as desk computers, notebook computers, tablets, handheld devices, smart phones and smart televisions. With the convenience brought by USB, users could hardly use the electronic products without the USB interface. According to the USB specification, a computer can connect different USB devices via a USB hub, but cannot share these USB devices with another computer. To share a USB device, such as a USB keyboard, USB mouse, USB speaker, USB hard disk, USB printer and USB scanner, between two or more computers, a user must switch the connection of the USB device between two computers by frequently unplugging the USB device from one computer and then plugging the USB device into another computer. Such a switching approach is time-consuming and inefficient.

### SUMMARY

Embodiments according to the present invention provide an electronic apparatus coupled between one or more hosts and one or more Universal Serial Bus (USB) electronic devices. The electronic apparatus comprises a first USB device control module, a first virtual USB hub module, a USB host control module, and a microprocessor. The first USB device control module is configured to be electrically connected to a first host of the one or more hosts. The first virtual USB hub module corresponds to the first USB device control module. The USB host control module is configured to be electrically connected to a first USB electronic device of the one or more USB electronic devices via a USB hub module. The microprocessor is configured to generate the first virtual USB hub module in a memory.

In an embodiment, the microprocessor is configured to, in response to an event that the first host is electrically connected, enumerate at the first host the first virtual USB hub module via the USB device control module and, in response to an event that the first USB electronic device is electrically connected, enumerate the first USB electronic device via the USB hub module and the USB host control module.

In another embodiment, the microprocessor is configured to play as a role as the first virtual USB hub module and, in response to an event that the first USB electronic device is electrically connected, enumerate at the first host via the first USB electronic device module

In yet another embodiment, the electronic apparatus further comprises a priority arbitration module configured to, in response to the availability of the first USB electronic device, send a USB electric operation signal issued from first host via the USB host control module and the USB hub module to the USB electronic device.

In still another embodiment, the electronic apparatus further comprises a second USB device control module configured to be electrically connected to a second host of the one or more hosts, and a second virtual USB hub module corresponding to the second USB device control module. Moreover, the microprocessor is configured to play as a role as the second virtual USB hub module and, in response to an event that the second host is electrically connected, enumerate at the second host via the second virtual USB hub module.

In yet still another embodiment, the USB host control module is configured to be electrically connected to a second USB electronic device of the one or more USB electronic devices via the USB hub module, and the microprocessor is configured to, in response to an event that the second USB electronic device is electrically connected, enumerate the second USB electronic device via the USB hub module and the USB host control module.

In an embodiment, the microprocessor is configured to, in response to an event that the first USB electronic device is electrically connected, enumerate at the second host the first USB electronic device via the second virtual USB hub module.

In another embodiment, the microprocessor is configured to, in response to an event that the second USB electronic device is electrically connected, enumerate at the first host the second USB electronic device via the first virtual USB hub module.

In still another embodiment, the microprocessor is configured to, in response to an event that the second USB electronic device is electrically connected, enumerate at the second host the second USB electronic device via the second virtual USB hub module.

In yet another embodiment, the first USB device control module comprises a filter configured to store a device address and an endpoint address of a USB electronic device, and a USB transceiver and a USB serial interface engine configured to, in response to a USB electric signal from the first host, compare a device address and an end point address in the USB electric signal with the device address and end point address in the filter.

In yet still another embodiment, the microprocessor is configured to, in response to an event that the first USB electronic device is electrically connected, set a physical address for the first USB electronic device and provide a data packet on USB device enumeration signal.

In an embodiment, the electronic apparatus further comprises a data transfer module configured to send the data packet on USB device enumeration signal to another electronic apparatus, and receive another data packet on USB device enumeration signal from the other electronic apparatus.

In another embodiment, the other data packet on USB device enumeration signal contains data regarding another USB electronic device electrically connected to the other electronic apparatus, wherein the microprocessor is configured to, in response to the other data packet on USB device enumeration signal, enumerate at the first host the other USB electronic device via the first virtual USB hub module.

Some embodiments according to the present invention provide a method of sharing USB electronic devices among one or more hosts. The method comprises providing a first virtual USB hub module in a first electronic apparatus, the first electronic apparatus to be electrically connected between the one or more hosts and one or more USB electronic devices, enumerating, at a first host of the one or more hosts that is electrically connected to the first electronic apparatus and corresponds to the first virtual USB hub module, a first USB electronic device electrically connected to the first electronic apparatus, via the first virtual USB hub module, and sending an electric signal issued from the first host to the first USB electronic device in response to the availability of the first USB electronic device.

In an embodiment, the method further comprises providing a second virtual USB hub module in the first electronic apparatus, enumerating, at a second host of the one or more hosts that is electrically connected to the first electronic apparatus and corresponds to the second virtual USB hub module, the first USB electronic device electrically connected to the first electronic apparatus, via the second virtual USB hub module, and sending an electric signal issued from the second host to the first USB electronic device in response to the availability of the first USB electronic device.

In another embodiment, the method further comprises during data transfer between the first USB electronic device and the first host, sending a negative acknowledgement (NAK) data packet to the second host in response to a USB electric signal issued from the second host to the first USB electronic device.

In yet another embodiment, the method further comprises during data transfer between the first USB electronic device and the second host, sending a negative acknowledgement (NAK) data packet to the first host in response to a USB electric signal issued from the host to the first USB electronic device.

In still another embodiment, the method further comprises in response to an event that the first USB electronic device is electrically connected to the first electronic apparatus, providing a first data packet on USB device enumeration signal that contains data regarding the first USB electronic device.

In yet still another embodiment, the method further comprises receiving a second data packet on USB device enumeration signal from a second electronic apparatus through a communication protocol, the second electronic apparatus to be electrically connected between a third host and a third USB electronic device, and the second data packet on USB device enumeration signal containing data regarding the third USB electronic device, and enumerating, at the first host, the third USB electronic device via the first virtual USB hub module.

In an embodiment, the method further comprises enumerating, at the second host, the third USB electronic device via the second virtual USB hub module.

In the above-mentioned embodiments, once hosts and USB electronic devices, which have performed enumeration processes, stay unplugged from the electronic apparatus, no enumeration process is required for these hosts and USB electronic devices during switching. As a result, the invention enables multiple hosts to share the resources of multiple USB electronic devices, and achieves efficient switching among the multiple hosts and multiple USB electronic devices number of hosts during operation.

The foregoing has outlined rather broadly the features and technical advantages of the present invention in order that the detailed description of the invention that follows may be better understood. Additional features and advantages of the invention will be described hereinafter, and form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

Embodiments, or examples, of the disclosure illustrated in the drawings are now described using specific languages. It will nevertheless be understood that no limitation of the scope of the disclosure is thereby intended. Any alterations and modifications in the described embodiments, and any further applications of principles described in this document are contemplated as would normally occur to one of ordinary skill in the art to which the disclosure relates. Reference numbers may be repeated throughout the embodiments, but this does not necessarily require that feature(s) of one embodiment apply to another embodiment, even if they share the same reference number.

It will be understood that when an element is referred to as being “connected to” or “coupled to” another element, it may be directly connected to or coupled to the other element, or intervening elements may be present.

The objectives and advantages of the present invention are illustrated with the following description and upon reference to the accompanying drawings, in which:

FIG. 1 is a schematic diagram of a system including an electronic apparatus, hosts and USB electronic devices, in accordance with an embodiment of the present invention.

FIG. 2 is a block diagram of the electronic apparatus illustrated in FIG. 1, in accordance with an embodiment of the present invention.

FIG. 3 is a block diagram of an electronic apparatus, in accordance with another embodiment of the present invention.

FIG. 4 is a block diagram of a system for sharing USB electronic devices, in accordance with an embodiment of the present invention.

FIG. 5 is a flow diagram showing a method of sharing USB electronic devices, in accordance with an embodiment of the present invention.

FIG. 6 is a flow diagram showing a method of sharing USB electronic devices, in accordance with another embodiment of the present invention.

### DETAILED DESCRIPTION

The embodiments of the present invention are shown in the following description with the drawings, wherein similar or same components are indicated by similar reference numbers.

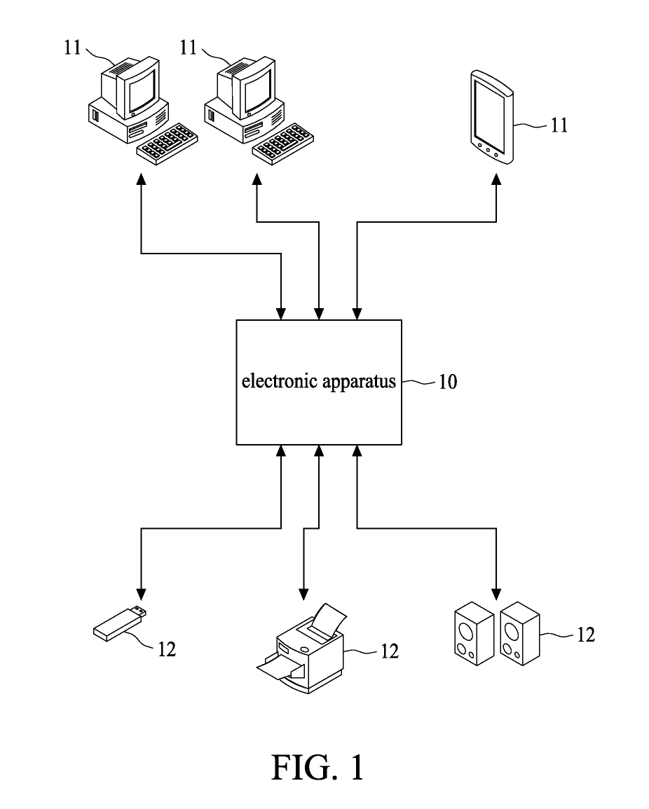

FIG. 1 is a schematic diagram of a system including an electronic apparatus 10, hosts 11 and USB electronic devices 12, in accordance with an embodiment of the present invention. Referring to FIG. 1, the electronic apparatus 10 is electrically connected between the hosts 11 and the USB electronic devices 12. The electronic apparatus 10 is configured to enable the hosts 11 to use the USB electronic devices 12 according to the availability of the USB electronic devices 12.

In an embodiment according to the present invention, the electronic apparatus 10 includes a field-programmable gate array (FPGA), an application-specific integrated circuit (ASIC) or a system-on-chip (SOC) chip. Moreover, the hosts 11 may include personal computers, handheld computers, tablets and smart phones. Furthermore, USB electronic devices 12 may include USB human-machine interface devices, USB storage devices, USB printers and other USB devices.

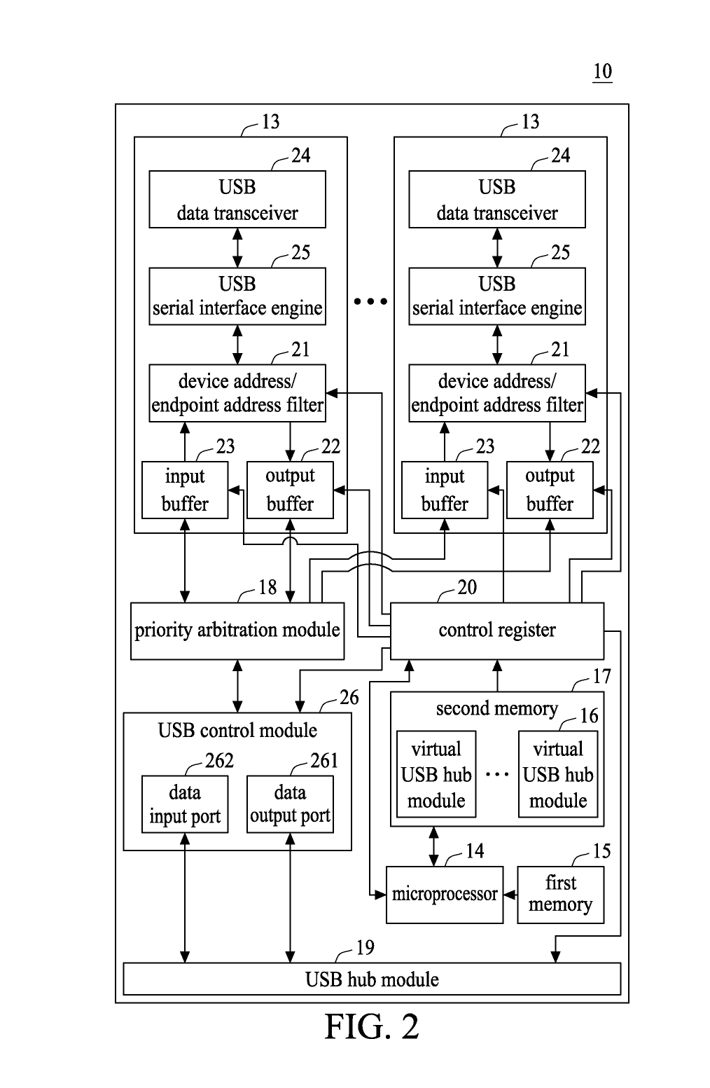

FIG. 2 is a block diagram of the electronic apparatus 10 illustrated in FIG. 1, in accordance with an embodiment of the present invention. Referring to FIG. 2 and also to FIG. 1, the electronic apparatus 10 includes a number of USB device control modules 13, a microprocessor 14, a priority arbitration module 18, a USB host control module 26 and a USB hub module 19.

The microprocessor 14, coupled to a first memory 15, is configured to generate a number of virtual USB hub modules 16 in a second memory 17 by performing program instructions in the first memory 15. Each of the virtual USB hub modules 16 corresponds to one of the USB device control modules 13. In an embodiment according to the present invention, the first memory 15 includes a flash memory, while the second memory 17 includes a random access memory.

Moreover, the microprocessor 14 is configured to, by performing the program instructions in the first memory 15, frequently detect whether any hosts 11 is electrically connected to any USB device control modules 13, and frequently detect whether any USB electronic devices 12 is electrically connected to the USB hub module 19. In an embodiment according to the present invention, the USB hub module 19 includes a USB hub.

When the virtual USB hub modules 16 are generated in the second memory 17, an endpoint data buffer (not shown) for each of the virtual USB hub modules 16 is also generated in the second memory 17. In addition, a device address and an endpoint address of each of the virtual USB hub modules 16 are stored, via a control register 20, in a device address/endpoint address filter 21, a hash table (not shown) in an output buffer 22, and a hash table (not shown) in an input buffer 23 in a corresponding one of the USB device control modules 13.

When the microprocessor 14 detects, via a USB device control module 13, an event that a host 11 is electrically connected to the electronic apparatus 10, the microprocessor 14 generates a USB electric connection signal in response to the connection event, and sends the same to the host 11 via the USB device control module 13 corresponding to the host 11. Subsequently, the host 11 starts to send a USB electric data signal to the corresponding USB device control module 13. The USB electric data signal includes an effective USB handshake signal. Further, the USB electric data signal is received by a USB data transceiver 24, and then decoded by a USB serial interface engine 25. The device address and endpoint address contained in the USB electric data signal are compared with setup data (device address and endpoint address) stored in the device address/endpoint address filter 21. If the comparison reveals that the device address and endpoint address contained in the USB electric data signal are effective, the USB device control module 13 sends the USB electric data signal to the output buffer 22 and compares the same with effective data (device address and endpoint address) in the hash table in the output buffer 22.

Next, in response to a result of comparison in the hash table of the output buffer 22, the USB device control module 13 sends the effective data in the USB electric data signal from the output buffer 22 to an endpoint data buffer (not shown) in a virtual USB hub module 16 in the second memory 17 that corresponds to the endpoint address of the effective data. The USB device control module 13 then generates an interrupt signal, indicating that an output operation is completed, and sends the interrupt signal to the microprocessor 14. Moreover, the USB device control module 13 sets, in the hash table of the output buffer 22 and the hash table of the input buffer 23, a waiting flag at an endpoint address corresponding to the device (the USB hub module 16), and keeps sending a negative-acknowledgement (NAK) data packet during a subsequent data stage or status stage of the host 11, thereby keeping the host 11 at a waiting state.

Since the receiver (the device address) of the USB electric data signal is the virtual USB hub module 16, the interrupt signal is processed by the microprocessor 14 in a virtual hub module procedure. By performing the procedure, continuous USB device enumeration data packets are generated in accordance with a standard enumeration process for USB hub based on the format of the effective data. The USB device enumeration data packets are sent via the USB device control module 13 to the host 11 so as to enumerate the virtual USB hub module 16. Moreover, the standard enumeration process includes storing data for response to the host 11 in the input buffer 23, and setting the hash table. When the host 11 generates a USB electric signal for an input request, the hash table in the input buffer 23 of the USB device control module 13 is checked and a wait-for-an-input flag in the hash table corresponding to the data for response to the host 11 is identified. The USB device control module 13 then sends the USB device enumeration data packet to the host 11.

When the USB electronic device 12 is electrically connected to the electronic apparatus 10, the microprocessor 14 executes program instructions to control the USB host control module 26. The microprocessor 14 serially reads and analyzes, via the USB host control module 26 and the USB hub module 19, the device descriptor and configuration descriptor of the USB electronic device 12 in accordance with the standard enumeration procedure, and sets a physical address for the USB electronic device 12. The microprocessor 14 thereby enumerates the USB electronic device 12 for the host 11 via the virtual USB hub module 16. Moreover, in response to the device descriptor, configuration descriptor and physical address of the USB electronic device 12, the microprocessor 14 creates an index data in the device address/endpoint address filter 21, the hash table in the output buffer 22 and the hash table in the input buffer 23 for ready reference by the host 11 in operating the USB electronic device 12. In an embodiment according to the present invention, the USB host control module 26 includes a USB host controller.

The priority arbitration module 18, coupled to the USB device control modules 13, is configured to, in response to the availability of the USB electronic device 12, send the USB electric signal data packets issued from the host 11 via the USB host control module 26 and the USB hub module 19 to the USB electronic device 12 to facilitate the host 11 to operate the USB electronic device 12.

When the USB electronic device 12 is electrically connected to the USB hub module 19, if the host 11 would like to operate the USB electronic device 12, the host 11 issues a standard USB electric signal data packet to the USB device control module 13 of the electronic apparatus 10. The USB electric signal data packet is received by the USB data transceiver 24 of the USB device control module 13, and then decoded by the USB serial interface engine 25 of the USB device control module 13. The USB electric signal data packet is compared in the device address/endpoint address filter 21 with respect to device address and endpoint address before sent to the output buffer 22.

Based on the result of comparison in the hash table of the output buffer 22, if the device address and endpoint address in the USB electric signal data packet refer to the USB electronic device 12, the USB device control module 13 sets a waiting flag in the hash table of the output buffer 22 and the hash table of the input buffer 23 for an endpoint address corresponding to the USB electronic device 12. Moreover, the USB device control module 13, during the subsequent data stage and status stage of the host 11, temporarily keeps sending a NAK data packet as a response to the host 11 so as to keep the host 11 at a waiting state. The priority arbitration module 18 determines, based on the availability of the USB electronic device 12, whether there are commands or communication pending for the USB electronic device 12. If the USB electronic device 12 is idle, the priority arbitration module 18, in response to the hash table of the output buffer 22, amends the device address in the USB electric signal data packet, for the host 11 to communicate with the USB electronic device 12, to the physical address set by the USB host control module 26 for the USB electronic device 12. The USB host control module 26 then sends the USB electric signal data packet via the USB hub module 19 to the USB electronic device 12.

The USB electronic device 12, in response to the USB electric signal data packet, issues a USB electric feedback signal to the priority arbitration module 18 via the USB hub module 19 and a data input 262 of the USB host control module 26. The priority arbitration module 18 amends the physical address in the data packet of the USB electric feedback signal to the virtual address of the USB electronic device 12 corresponding to the host 11, sends the same to the input buffer 23 of a USB device control module 13 that corresponds to the host 11, and sets the hash table thereof. When the host 11 issues a request for data input to the USB electronic device 12, the corresponding USB device control module 13, by a comparison in the hash table, sends effective data responsive to the request in the input buffer 23 to the host 11.

In addition, during communication between the host 11 and the USB electronic device 12, if the priority arbitration module 18 determines that it is required to await the USB electric signal data packet, which means that the USB electronic device 12 is currently not available, the priority arbitration module 18 keeps awaiting until the USB electronic device 12 becomes available before enables a communications between the host 11 and the USB electronic device 12.

As a result, the present invention provides a mechanism for a number of hosts 11 to share a number of USB electronic devices 12 in real time via the electronic apparatus 10. That is, the electronic apparatus 10 is able to enumerate simultaneously a number of USB electronic devices 12 for a number of hosts 11, and enable communications between these hosts 11 and USB electronic devices 12. Further, with the virtual USB hub module 16 and the priority arbitration module 18 of the electronic apparatus 10, during switching of the USB electronic devices 12 among the hosts 11, there is no need to re-enumerate the USB electronic devices 12 for the hosts 11, so that forced disconnection between the hosts 11 and USB electronic devices 12 can be avoided. Moreover, the virtual USB hub module 16 and the priority arbitration module 18 may be configured that a specific USB electronic device 12 can only be used by a specific host 11. Alternatively, for the purpose of management, some USB electronic devices are not available for some hosts. Alternatively, some USB electronic devices are only available for some hosts. As such, the security of using the USB electronic devices is enhanced. For example, only a USB electronic device with a specific vendor identifier (VID) or a specific product identifier (PID) is available, or unavailable, for a specific host. Alternatively, only a USB device with a specific class is available, or unavailable, for a specific host.

In existing approaches, there exists a pointer to pointer relationship between a host and a USB electronic device. When another host would like to use a USB electronic device, the original host using the USB electronic device needs to electrically disconnect the USB electronic device to allow the other host to electrically connect and enumerate the USB electronic device. In the present disclosure, however, for any hosts and USB electronic devices that have undergone an enumeration process, once such hosts and USB electronic devices stay electrically connected, no re-enumeration is required among the hosts and USB electronic devices during a switching operation. As a result, the present invention enables multiple hosts to share the resources of multiple USB electronic devices, and achieves an efficient switching among these hosts and USB electronic devices in applications involving multiple hosts and multiple USB electronic devices.

In an exemplary scenario, it is assumed that the electronic apparatus 10 is electrically connected to a first host and a second host via a first USB device control module and a second USB device control module, respectively, and is electrically connected to a first USB electronic device and a second USB electronic device via a USB hub module. Moreover, it is assumed that an enumeration process between the host and each of the USB electronic devices has been done. When operation data are transmitted between the first host and the first USB electronic device, the second USB device control module 13 of the electronic apparatus 10 replies a NAK signal in response to a USB electric signal issued from the second host to the first USB electronic device. Moreover, when operation data are transmitted between the first host and the second USB electronic device, the second USB device control module 13 of the electronic apparatus 10 replies a NAK signal in response to a USB electric signal issued from the second host to the second USB electronic device. Similarly, when operation data are transmitted between the second host and the first USB electronic device or the second USB electronic device, the first USB device control module 13 of the electronic apparatus 10 replies a NAK signal in response to a USB electric signal issued from the first host to the first USB electronic device or the second USB electronic device. In addition, when electric connection is switched from the first host to the second host, since the index data associated with the second host and the first and second USB electronic devices have been created in the second USB device control module in an enumeration process earlier performed, operation data can be transmitted between the second host and the first and second USB electronic devices without re-enumerating the first and second USB electronic devices for the second host. Similarly, when electric connection is switched from the second host to the first host, since the index data associated with the first host and the first and second USB electronic devices have been created in the first USB device control module in an enumeration process earlier performed, operation data can be transmitted between the first host and the first and second USB electronic devices without re-enumerating the first and second USB electronic devices for the first host.

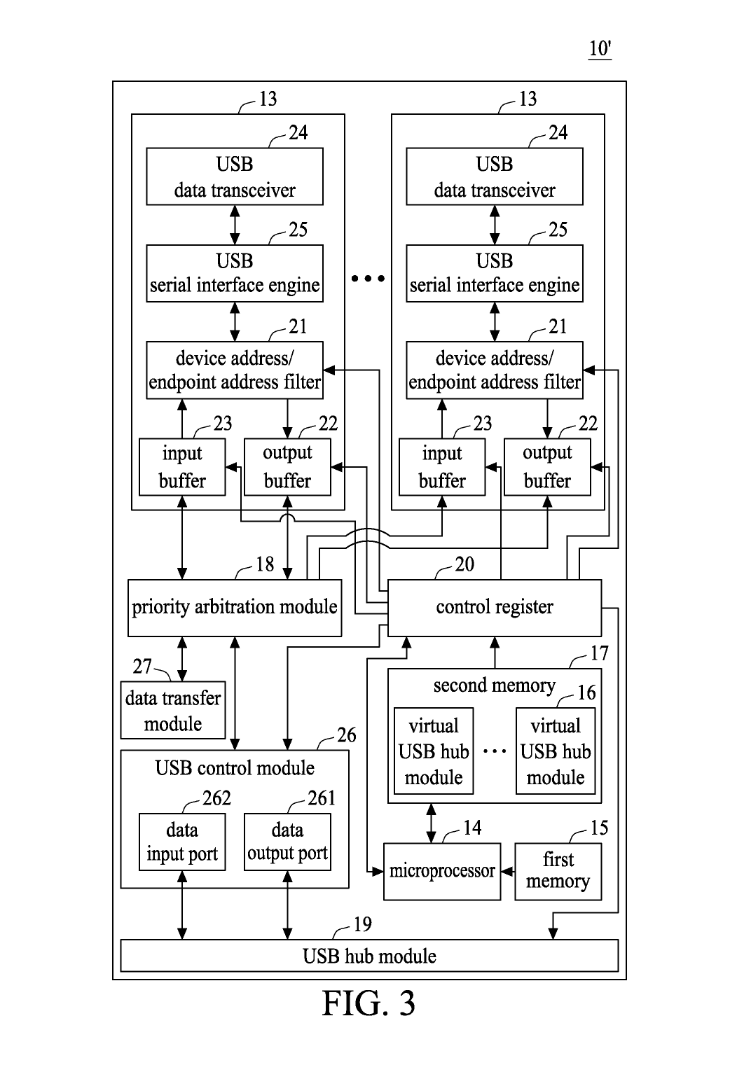

FIG. 3 is a block diagram of an electronic apparatus 10′, in accordance with another embodiment of the present invention. As compared to the electronic apparatus 10 described and illustrated with reference to FIG. 1, the electronic apparatus 10′ further includes a data transfer module 27, which is coupled to the priority arbitration module 18. When the USB hub module 19 of the electronic apparatus 10′ is electrically connected to a USB electronic device, the microprocessor 14 of the electronic apparatus 10′ executes program instructions to control the USB host control module 26. The microprocessor 14 serially reads and analyzes the device descriptor and configuration descriptor of the USB electronic device in accordance with the standard enumeration procedure and sets a physical address for the USB electronic device in order to provide a USB electric enumeration signal data packet. The data transfer module 27 sends the USB electric enumeration signal data packet through a communication protocol to another electronic apparatus 10′. Likewise, the data transfer module 27 of the electronic apparatus 10′ can receive USB electric signal data packets from the other electronic apparatus 10′.

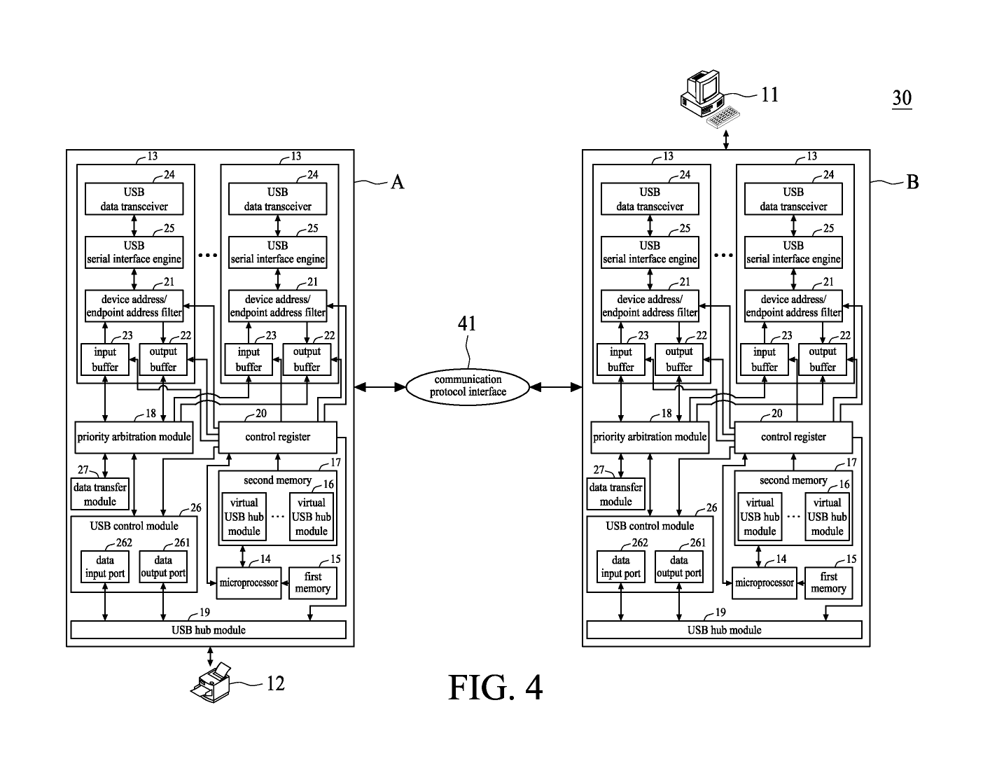

FIG. 4 is a block diagram of a system 30 for sharing USB electronic devices, in accordance with an embodiment of the present invention. Referring to FIG. 4, the system 30 includes at least two electronic apparatuses A and B, which are similar to the electronic apparatus 10′ in structure and function. The first electronic apparatus A and the second electronic apparatus B exchanges USB electric data via a predetermined communication protocol interface 41. The communication protocol interface 41 may operate in a wired or wireless communication protocol. In an embodiment according to the present invention, the communication protocol includes serial peripheral interface (SPI), universal asynchronous receiver/transmitter (UART) protocol, transmission control protocol/internet protocol (TCP/IP) and Wi-Fi. When the USB hub module 19 of the first electronic apparatus A is electrically connected to a USB electronic device 12, the microprocessor 14 of the first electronic apparatus A executes program instructions to control the USB host control module 26 in the first electronic apparatus A. The microprocessor 14 serially reads and analyzes the device descriptor and configuration descriptor of the USB electronic device 12 in accordance with the standard enumeration procedure and sets a physical address for the USB electronic device 12 in order to provide a data packet on USB electric enumeration signal. The data transfer module 27 of the first electronic apparatus A sends the data packet on USB electric enumeration signal through a communication protocol interface to the second electronic apparatus B.

After the data transfer module 27 of the second electronic apparatus B receives the data packet on USB electric enumeration signal, the microprocessor 14 of the second electronic apparatus B, in response to the device descriptor, configuration descriptor and physical address of the USB electronic device 12, creates an index data in the device address/endpoint address filter 21, the hash table in the output buffer 22 and the hash table in the input buffer 23 for ready reference by the host 11 in operating the USB electronic device 12. Furthermore, the virtual USB hub module 16 of the second electronic apparatus B enumerates the USB electronic device 12 for a host 11 electrically connected to the second electronic apparatus B.

If the host 11 would like to operate the USB electronic device 12, the host 11 generates a USB electric operation signal data packet and sends the same to the second electronic apparatus B. The USB data transceiver 24 of the USB device control module 13 in the second electronic apparatus B receives the USB electric operation signal. Then, the USB serial interface engine 25 of the USB device control module 13 in the second electronic apparatus B decodes the USB electric signal and the device address and endpoint address therein. The decoded addresses are compared in the device address/endpoint address filter 21. If the device address and endpoint address are determined to be effective, the USB electric signal is sent to the output buffer 22. Moreover, a waiting flag is set in the hash table of the output buffer 22 and the hash table of the input buffer 23 for an endpoint address corresponding to the USB electronic device 12. Moreover, the USB device control module 13, during the subsequent data stage and status stage of the host 11, temporarily keeps sending a NAK data packet as a response to the host 11 so as to keep the host 11 at a waiting state.

In the meantime, the priority arbitration module 18 of the second electronic apparatus B, in response to the hash table of the output buffer 22, amends the device address in the USB electric operation signal, for the host 11 to communicate with the USB electronic device 12, to the physical address set by the USB host control module 26 of the first electronic apparatus A for the USB electronic device 12. Moreover, the priority arbitration module 18 enables the data transfer module 27 to send the USB electric operation signal via the communication protocol interface 41 to the data transfer module 27 of the first electronic apparatus A. Next, the data transfer module 27 of the first electronic apparatus A sends the USB electric operation signal to the priority arbitration module 18 of the first electronic apparatus A, which in turn determines, based on the availability of the USB electronic device 12, whether there are commands or communication pending for the USB electronic device 12. If the USB electronic device 12 is idle, the USB electric operation signal is reproduced and sent to the data output 261 of the USB host control module 26. Subsequently, the USB host control module 26 sends the USB electric operation signal via the USB hub module 19 to the USB electronic device 12.

The USB electronic device 12, in response to the USB electric operation signal, generates a USB electric feedback signal and sends the same to the priority arbitration module 18 via the USB hub module 19 and the data input 262 of the USB host control module 26 in the first electronic apparatus A. The priority arbitration module 18 sends the data in the USB electric feedback signal via the communication protocol interface 41 to the data transfer module 27 of the second electronic apparatus B. The priority arbitration module 18 of the second electronic apparatus B amends the physical address in the data to the virtual address of the USB electronic device 12 corresponding to the host 11, sends the same to the input buffer 23 of a USB device control module 13 that corresponds to the host 11, and sets the hash table thereof. When the host 11 issues a request for data input to the USB electronic device 12 of the second electronic apparatus B, data responsive to the request in the input buffer 23 of the corresponding USB device control module 13 in the second electronic apparatus B is sent to the host 11.

If the priority arbitration module 18 in the first electronic apparatus A determines that it is required to await the USB electric operation signal data packet, which means that the USB electronic device 12 is currently not available, the first electronic apparatus A temporarily stores the USB electric operation signal data packet until the USB electronic device 12 becomes available. The priority arbitration module 18 then automatically sends the USB electric operation signal data packet to the USB electronic device 12.

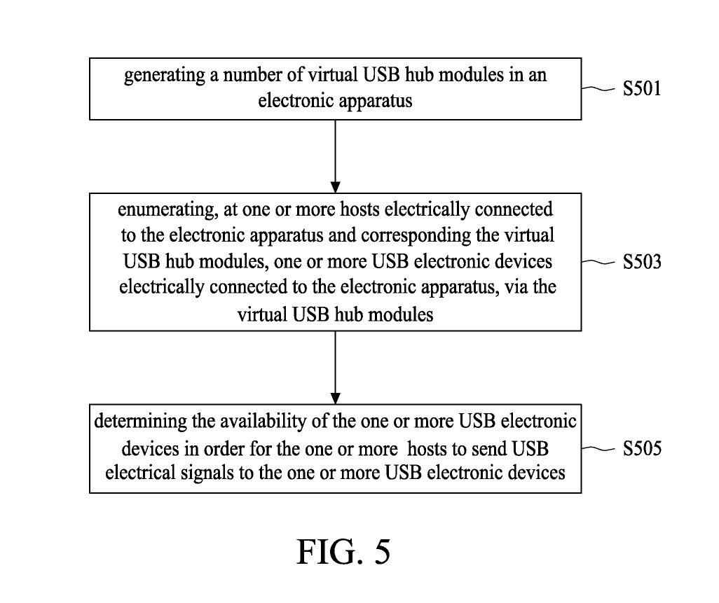

Given the above, the present disclosure further provides a method of sharing USB electronic devices. FIG. 5 is a flow diagram showing a method of sharing USB electronic devices, in accordance with an embodiment of the present invention. Referring to FIG. 5, in operation 5501, a number of virtual USB hub modules are generated in an electronic apparatus.

In operation 5503, one or more USB electronic devices electrically connected to the electronic apparatus are enumerated, via the virtual USB hub modules, at one or more hosts electrically connected to the electronic apparatus and corresponding to the virtual USB hub modules.

In operation 5505, the availability of the one or more USB electronic devices is determined so as to send a USB electric signal issued from the one or more hosts to the USB electronic devices.

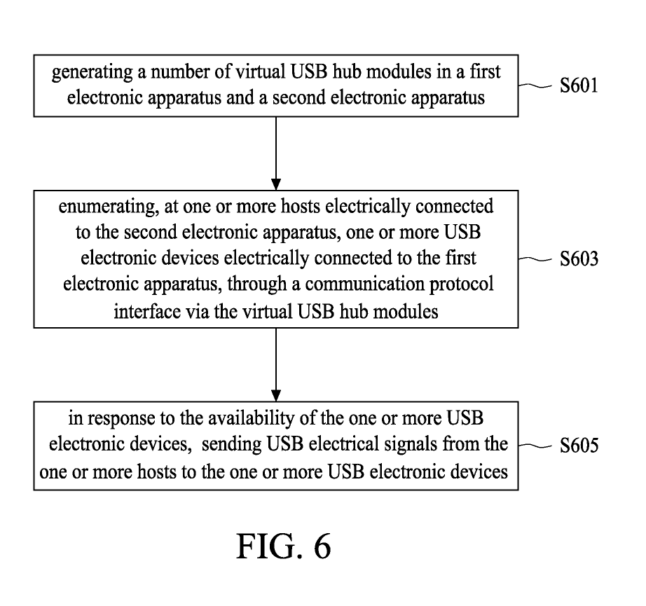

FIG. 6 is a flow diagram showing a method of sharing USB electronic devices, in accordance with another embodiment. Referring to FIG. 6, in operation S601, a number of virtual USB hub modules are generated in a first electronic apparatus and a second electronic apparatus.

In operation S603, a data packet on USB electric enumeration signal from a first USB electronic device electrically connected to the first electronic apparatus is sent via a communication protocol interface to the second electronic apparatus. Moreover, the first USB electronic device is enumerated, via the virtual USB hub modules in the second electronic apparatus, at a second host of one or more hosts corresponding to the virtual USB hub modules of the second electronic apparatus and electrically connected to the second electronic apparatus.

In operation S605, a USB electric signal of the second host is sent to the first electronic apparatus and, in response to the availability of the first USB electronic device in the first electronic apparatus, sent to the first USB electronic device via the communication protocol interface.

In an embodiment according to the present invention, in operation S603 a data packet on USB electric enumeration signal from a second USB electronic device electrically connected to the second electronic apparatus is sent via the communication protocol interface to the first electronic apparatus. Moreover, the second USB electronic device is enumerated, via the virtual USB hub modules in the first electronic apparatus, at a first host of one or more hosts corresponding to the virtual USB hub modules of the first electronic apparatus and electrically connected to the first electronic apparatus. Subsequently, in operation S605 a USB electric signal of the first host is sent to the second electronic apparatus and, in response to the availability of the second USB electronic device in the second electronic apparatus, sent to the second USB electronic device via the communication protocol interface.

Although the present invention and its advantages have been described in detail, it should be understood that various changes, substitutions and alterations can be made herein without departing from the spirit and scope of the invention as defined by the appended claims. For example, many of the operations discussed above can be implemented in different methodologies and replaced by other operations, or a combination thereof.

Moreover, the scope of the present application is not intended to be limited to the particular embodiments of the process, machine, methods and steps described in the specification. As one of ordinary skill in the art will readily appreciate from the disclosure of the present invention, processes, machines, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, methods, or steps.

What is claimed is:

1. An electronic apparatus, coupled between one or more hosts and one or more Universal Serial Bus (USB) electronic devices, the electronic apparatus comprising:
a first USB device control module, configured to be electrically connected to a first host of the one or more hosts;
a first virtual USB hub module, corresponding to the first USB device control module;
a USB host control module, configured to be electrically connected to a first USB electronic device of the one or more USB electronic devices via a USB hub module; and
a microprocessor, configured to generate the first virtual USB hub module in a memory.

2. The electronic apparatus of claim 1, wherein the microprocessor is configured to work as the first virtual USB hub module and, in response to an event that the first host is electrically connected, enumerate at the first host via the USB device control module and, in response to an event that the first USB electronic device is electrically connected, enumerate the first USB electronic device via the USB hub module and the USB host control module.

3. The electronic apparatus of claim 1, wherein the microprocessor is configured to, in response to an event that the first USB electronic device is electrically connected, enumerate at the first host the first USB electronic device via the first virtual USB hub module.

4. The electronic apparatus of claim 1 further comprising a priority arbitration module configured to, in response to the availability of the first USB electronic device, send a USB electric operation signal issued from first host via the USB host control module and the USB hub module to the USB electronic device.

5. The electronic apparatus of claim 1 further comprising:
a second USB device control module, configured to be electrically connected to a second host of the one or more hosts; and
a second virtual USB hub module, corresponding to the second USB device control module,
wherein the microprocessor is configured to, in response to an event that the second host is electrically connected, enumerate at the second host the second virtual USB hub module via the second USB device control module.

6. The electronic apparatus of claim 5, wherein the USB host control module is configured to be electrically connected to a second USB electronic device of the one or more USB electronic devices via the USB hub module, and the microprocessor is configured to, in response to an event that the second USB electronic device is electrically connected, enumerate the second USB electronic device via the USB hub module and the USB host control module.

7. The electronic apparatus of claim 6, wherein the microprocessor is configured to, in response to an event that the first USB electronic device is electrically connected, enumerate at the second host the first USB electronic device via the second virtual USB hub module.

8. The electronic apparatus of claim 6, wherein the microprocessor is configured to, in response to an event that the second USB electronic device is electrically connected, enumerate at the first host the second USB electronic device via the first virtual USB hub module.

9. The electronic apparatus of claim 6, wherein the microprocessor is configured to, in response to an event that the second USB electronic device is electrically connected, enumerate at the second host the second USB electronic device via the second virtual USB hub module.

10. The electronic apparatus of claim 1, wherein the first USB device control module comprises:
a filter, configured to store a device address and an endpoint address of a USB electronic device; and
a USB transceiver and a USB serial interface engine configured to, in response to a USB electric signal from the first host, compare a device address and an end point address in the USB electric signal with the device address and end point address in the filter.

11. The electronic apparatus of claim 1, wherein the microprocessor is configured to, in response to an event that the first USB electronic device is electrically connected, set a physical address for the first USB electronic device and provide a data packet on USB device enumeration signal.

12. The electronic apparatus of claim 11 further comprising:
a data transfer module, configured to send the data packet on USB device enumeration signal to another electronic apparatus, and receive another data packet on USB device enumeration signal from the other electronic apparatus.

13. The electronic apparatus of claim 12, wherein the other data packet on USB device enumeration signal contains data regarding another USB electronic device electrically connected to the other electronic apparatus, wherein the microprocessor is configured to, in response to the other data packet on USB device enumeration signal, enumerate at the first host the other USB electronic device via the first virtual USB hub module.

14. A method of sharing USB electronic devices among one or more hosts, the method comprising:
providing a first virtual USB hub module in a first electronic apparatus, the first electronic apparatus to be electrically connected between the one or more hosts and one or more USB electronic devices;
enumerating, at a first host of the one or more hosts that is electrically connected to the first electronic apparatus and corresponds to the first virtual USB hub module, a first USB electronic device electrically connected to the first electronic apparatus, via the first virtual USB hub module; and
sending an electric signal issued from the first host to the first USB electronic device in response to the availability of the first USB electronic device.

15. The method of claim 14 further comprising:
providing a second virtual USB hub module in the first electronic apparatus;
enumerating, at a second host of the one or more hosts that is electrically connected to the first electronic apparatus and corresponds to the second virtual USB hub module, the first USB electronic device electrically connected to the first electronic apparatus, via the second virtual USB hub module; and
sending an electric signal issued from the second host to the first USB electronic device in response to the availability of the first USB electronic device.

16. The method of claim 15 further comprising:
during data transfer between the first USB electronic device and the first host, sending a negative acknowledgement (NAK) data packet to the second host in response to a USB electric signal issued from the second host to the first USB electronic device.

17. The method of claim 15 further comprising:
during data transfer between the first USB electronic device and the second host, sending a negative acknowledgement (NAK) data packet to the first host in response to a USB electric signal issued from the host to the first USB electronic device.

18. The method of claim 15 further comprising:
in response to an event that the first USB electronic device is electrically connected to the first electronic apparatus, providing a first data packet on USB device enumeration signal that contains data regarding the first USB electronic device.

19. The method of claim 18 further comprising:
receiving a second data packet on USB device enumeration signal from a second electronic apparatus through a communication protocol, the second electronic apparatus to be electrically connected between a third host and a third USB electronic device, and the second data packet on USB device enumeration signal containing data regarding the third USB electronic device; and
enumerating, at the first host, the third USB electronic device via the first virtual USB hub module.

20. The method of claim 19 further comprising:
enumerating, at the second host, the third USB electronic device via the second virtual USB hub module.
